(19) United States
(12) Patent Application Publication
(10) Pub. No.: US 2022/0301029 A1
(43) Pub. Date: Sep. 22, 2022

(54) INFORMATION DELIVERY SYSTEM, INFORMATION DELIVERY METHOD, AND STORAGE MEDIUM

(71) Applicant: HONDA MOTOR CO., LTD., Tokyo (JP)

(72) Inventors: Leo ITO, Tokyo (JP); Jingwen HAN, Tokyo (JP); Tomohiro TSUKAMOTO, Wako-shi, Saitama (JP); Eriko OKABE, Wako-shi, Saitama (JP); Yuichi KAWASAKI, Wako-shi, Saitama (JP); Misato FUKUSHIMA, Tokyo (JP)

(21) Appl. No.: 17/672,184

(22) Filed: Feb. 15, 2022

(30) Foreign Application Priority Data
Mar. 18, 2021 (JP) 2021-045146

(51) Int. Cl. G06Q 30/06

(52) U.S. Cl. CPC G06Q 30/0617; G06Q 30/0609

(57) ABSTRACT

An information delivery system comprises: a user information storage unit configured to store user information; a reservation information storage unit configured to store reservation information accepted from a user in association with the user information; an authentication unit configured to authenticate a visiting user who enters a facility on the basis of a comparison between information acquired from an image of the visiting user and the user information; a checking unit configured to check the information about the visiting user authenticated by the authentication unit against the reservation information stored in the reservation information storage unit; and a communication unit configured to output, to a customer service support unit, visit information obtained by combining the information about the visiting user checked by the checking unit and the reservation information.

### CROSS-REFERENCE TO RELATED APPLICATION

This application claims priority to and the benefit of Japanese Patent Application No. 2021-045146 filed on Mar. 18, 2021, the entire disclosure of which is incorporated herein by reference.

### BACKGROUND OF THE INVENTION

### Field of the Invention

The present invention relates to an information delivery system, an information delivery method, and a storage medium.

### Description of the Related Art

In recent years, various techniques using robots have been proposed as one technique for solving labor shortage. Japanese Patent No. 6142306 discloses a technique in which a robot gives a description of an exhibit to a visitor (user) or guides a visitor (user) through an exhibition site, for example.

However, since a sales representative (facility staff) can grasp user information only after the reception of a visitor is completed, a visiting user may feel uneasy or customer service to the visiting user may be delayed until the sales representative grasps the user information after the arrival of the visiting user.

In view of the above problem, the present invention provides a technique that enables transmission of user information to a customer service support unit, so that information about a visiting user can be grasped to provide customer service.

### SUMMARY OF THE INVENTION

According to one aspect of the present invention, there is provided an information delivery system comprising: a user information storage unit configured to store user information; a reservation information storage unit configured to store reservation information accepted from a user in association with the user information; an authentication unit configured to authenticate a visiting user who enters a facility on the basis of a comparison between information acquired from an image of the visiting user and the user information; a checking unit configured to check the information about the visiting user authenticated by the authentication unit against the reservation information stored in the reservation information storage unit; and a communication unit configured to output, to a customer service support unit, visit information obtained by combining the information about the visiting user checked by the checking unit and the reservation information.

According to the present invention, by transmitting user information to the customer service support unit, it is possible to grasp information about a visiting user and provide customer service. For example, a sales representative (facility staff) can perform communication such as calling the name of the visiting user, and can proceed with smooth business negotiation.

### BRIEF DESCRIPTION OF THE DRAWINGS

FIG. 1 is a diagram illustrating a configuration example of an information delivery system;

FIG. 2 is a diagram in which ST21 illustrates a configuration example of a user information storage unit, and ST22 illustrates a configuration example of a reservation information storage unit;

FIG. 3 is a diagram for describing a configuration of a guide robot, in which ST31 illustrates an external configuration of the guide robot and ST32 illustrates a functional configuration of the guide robot;

FIG. 4 is a diagram in which ST41 illustrates a functional configuration of a terminal device, and ST42 illustrates a functional configuration of a camera unit;

FIG. 5 is a diagram illustrating an example of a store to which the information delivery system is applicable;

FIG. 6 is a diagram for describing a flow of processing in the information delivery system;

FIG. 7 is a diagram illustrating a display example of the terminal device that gives notification of a visiting user when there is change information;

FIG. 8 is a diagram illustrating a display example of the terminal device that gives notification of a visiting user when there is no change information; and

FIG. 9 is a diagram illustrating a display example of the terminal device that gives notification of a visiting user who is a new user.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

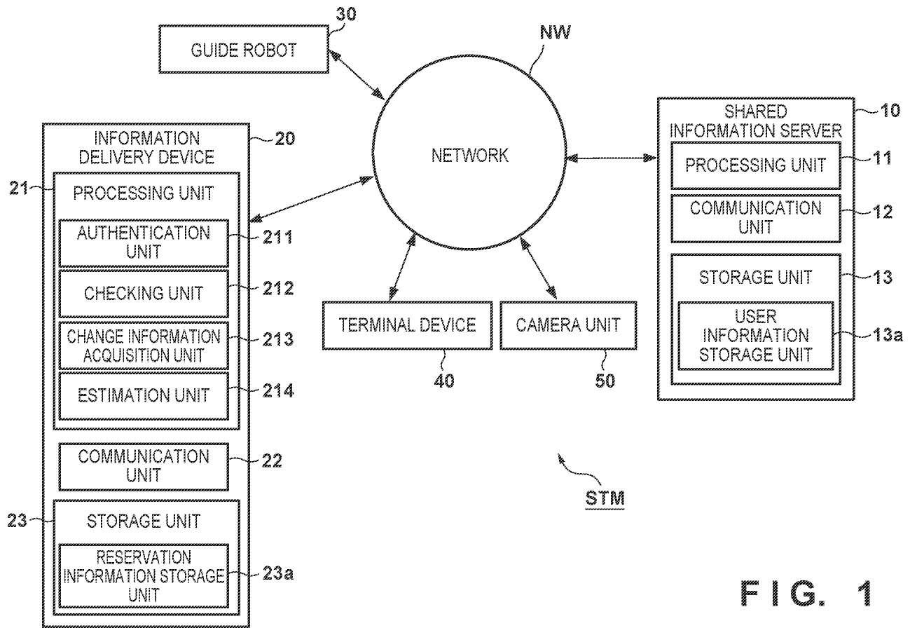

FIG. 1 is a diagram illustrating a configuration example of an information delivery system STM. The information delivery system STM includes a shared information server 10 functioning as a shared information server having a database shared by the entire system, an information delivery device 20 capable of communicating with the shared information server 10, a guide robot 30, a terminal device 40, and a camera unit 50 (imaging unit). The information delivery system STM is a system that provides the guide robot 30 and the terminal device 40 of a sales representative (facility staff) with information for serving customers. While the example of FIG. 1 illustrates a single information delivery device 20, the present invention is not limited to this example, and a plurality of information delivery devices 20 can be connected to a network NW.

The information delivery system STM is applied, for example, in a store 500 (showroom) of an automobile dealer.

The information delivery device 20 functioning as a server that manages store information is disposed in an office or the like in each store, and is capable of bidirectional communication, through the network NW, with the upper-level shared information server 10 that manages user information. Additionally, the information delivery device 20 can transmit (convey) information to the guide robot 30 that guides or provides customer service to a visiting user (visitor) in the store and to the terminal device 40 of a sales representative in the store. Additionally, the information delivery device 20 can receive an image (image information) from the camera unit 50 (imaging unit). The information delivery device 20 is capable of bidirectional communication with the shared information server 10, and is capable of performing various types of information processing on the basis of information acquired from the shared information server 10 and transmitting (conveying) the result to the guide robot 30 and the terminal device 40 in the store.

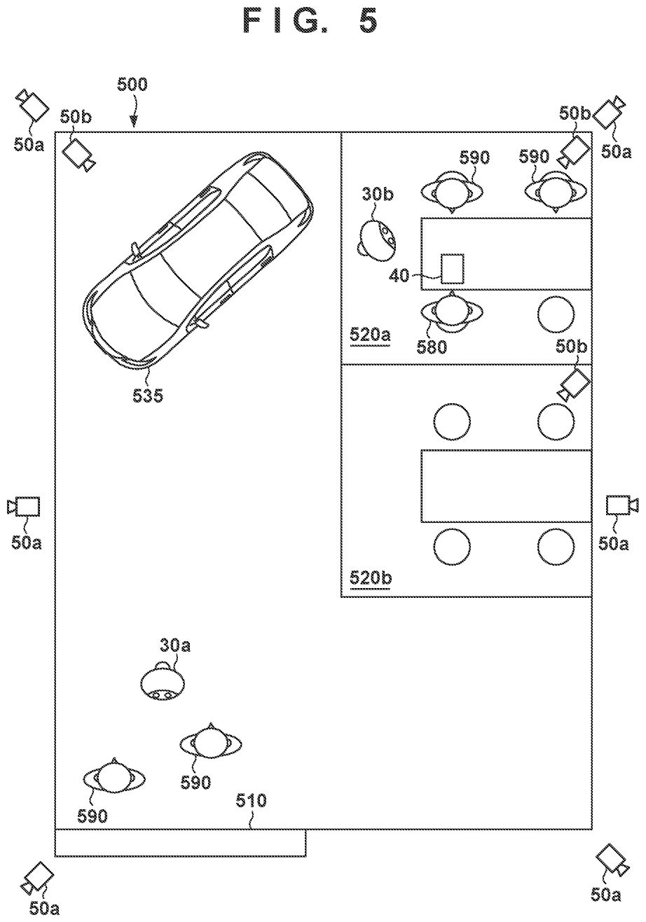

The guide robot 30 is a robot for guiding and providing customer service to a visiting user 590 at the store 500 (showroom). FIG. 5 illustrates a guide robot 30a that performs reception near an entrance 510 of the store 500 and a guide robot 30b that is present at a business negotiation between a sales representative 580 and the visiting user 590 in a business negotiation space 520a. In the following description, when referring to the robots with no distinction, the robots are referred to as the guide robot 30.

The terminal device 40 is a terminal operated by the sales representative 580. The sales representative 580 can use the terminal device 40 to present various materials related to a displayed vehicle 535 disposed in the store 500 to the visiting user 590, and confirm information about the visiting user 590 or the like.

The camera unit 50 is a unit that captures images of facilities inside the store 500 (showroom) and outside the store 500. In FIG. 5, camera units 50a that capture images of facilities outside the store 500, camera units 50b that capture images of the business negotiation spaces 520a and 520b, respectively, and a camera unit 50c that captures an image of the entire store 500 are provided. In the following description, when referring to the camera units 50a to 50c with no distinction, the camera units 50a to 50c are referred to as the camera unit 50.

A plurality of camera units 50 are disposed in the store 500, in a parking space outside the store 500, and in a walking space leading from the parking space to the store, and transmit captured image information to the information delivery device 20. Here, the parking space and the walking space leading from the parking space to the store which are spaces outside the store are referred to as facilities outside the store (or simply facilities).

The camera units 50b and 50c disposed in the store 500 capture a face image of the visiting user 590 who enters the store and transmit the face image to the information delivery device 20.

The camera unit 50a disposed in a facility outside the store captures an image of information on a license plate of a vehicle that enters the parking space, and transmits the image to the information delivery device 20. Additionally, the camera unit 50a disposed in a facility outside the store captures a face image of a visiting user in the walking space, and transmits the image to the information delivery device 20. The information delivery device 20 performs image processing on the basis of the image (image information) transmitted from the camera unit 50a disposed in the facility outside the store, and performs pre-authentication (authentication) of the visiting user.

Additionally, the information delivery device 20 can perform image processing on the basis of images (image information) transmitted from the camera unit 50a disposed in the facility outside the store and the camera units 50b and 50c disposed in the store, and perform pre-authentication of the visiting user.

(Configuration of Shared Information Server 10 (Shared Information Server))

The shared information server 10 includes a processing unit 11 (CPU), a communication unit 12, and a storage unit 13 as a hardware configuration. The processing unit 11 (central processing unit (CPU)) performs various types of processing for controlling the entire shared information server 10.

The communication unit 12 can transmit and receive data to and from the information delivery device 20 (robot server) disposed in each store through the network NW. The communication unit 12 can transmit various types of information stored in the storage unit 13 in response to a data request from the information delivery device 20.

The storage unit 13 includes a read only memory (ROM) for storing a program to be executed by the processing unit 11, and a random access memory (RAM) for storing various types of information as a work area when the processing unit 11 executes the program. Additionally, the storage unit 13 includes a mass storage unit that stores various types of information including user information. The storage unit 13 can be configured by a memory card, a flash memory, a hard disk drive (HDD), or the like. The storage unit 13 includes a user information storage unit 13a that stores user information.

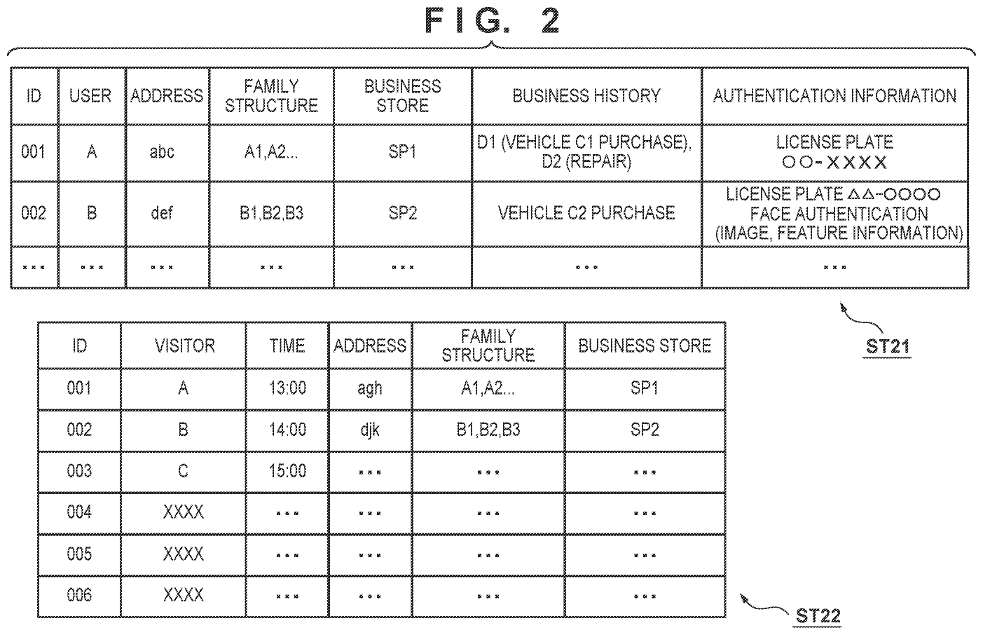

ST21 of FIG. 2 is a diagram illustrating a configuration example of the user information storage unit 13a. User information stored in the user information storage unit 13a includes a user ID and a user name for identifying the user, information on a user's address, a user's family structure, a business store, and a business history, and authentication information.

The information on the user's address, the user's family structure, the business store, and the business history is used as basic information for estimating the reason for visiting the store (reason for visit) of the visiting user. The information delivery device 20 can check user information (information on user's address, user's family structure, business store, and business history) corresponding to information (ID and user name) about the visiting user authenticated by pre-authentication against user information included in reservation information, and estimate the reason for visiting the store of the visiting user on the basis of change information on the changed item.

In the information on the business store, SP1, SP2, . . . , indicate business stores with which the users have transactions. By referring to the information on the business store, the information delivery device 20 can determine whether the visiting user is a user of another store or a user of the self-store.

The information on the business history includes information (D1 and the like: vehicle type, model year, grade, and the like) on the vehicle purchased by the user and information (date and time, cost, number of repairs, and the like) on the repair history (D2).

Authentication information includes information on the license plate of the vehicle used for pre-authentication of the visiting user, image information used for face authentication, and feature information obtained by quantifying the image information.

The information delivery device 20 specifies the corresponding visiting user (ID and user name) on the basis of a comparison between information (information acquired by image processing) acquired from an image (image information) transmitted from the camera unit 50 and user information (authentication information included in user information) acquired from the user information storage unit 13a of the shared information server 10.

Note that the example of user information is one example, and various types of information can be further combined.

ST22 in FIG. 2 is a diagram illustrating a configuration example of a reservation information storage unit 23a, and is associated with information stored in the user information storage unit 13a by the user IDs and the names of the visitors. Input information is information input by the visitor at the time of reservation, and can be compared with information stored in the user information storage unit 13a at the time of checking. Note that the example of input information is one example, and various types of information can be further combined.

The shared information server 10 can store information acquired by communication with the information delivery device 20 through the network NW in the storage unit 13 (user information storage unit 13a and reservation information storage unit 23a). Additionally, the processing unit 11 of the shared information server 10 can update information stored in the storage unit 13 on the basis of information acquired by communication with the information delivery device 20. The processing unit 11 can newly add user information or user reservation information or update information already stored, for example, on the basis of information acquired by communication with the information delivery device 20.

(Configuration of Information Delivery Device 20)

The information delivery device 20 includes a processing unit 21 (central processing unit (CPU)), a communication unit 22, and a storage unit 23.

The communication unit 22 can bidirectionally transmit and receive information to and from the shared information server 10 through the network NW. Additionally, the communication unit 22 can receive an image (image information) from the camera unit 50 (imaging unit) and transmit (convey) information to the guide robot 30 that provides customer service to a visitor in the store and the terminal device 40 of the sales representative in the store.

The storage unit 23 includes a ROM for storing a program executed by the processing unit 21, and a RAM for storing various types of information as a work area when the processing unit 21 executes the program. Additionally, the storage unit 23 includes a large-capacity storage unit that stores various types of information including various types of information received from the shared information server 10, results of various types of analysis processing by the processing unit 21, and reservation information on the user. The storage unit 23 can be configured by a memory card, a flash memory, a hard disk drive (HDD), or the like. The storage unit 23 includes a reservation information storage unit 23a that stores reservation information accepted from the user in association with user information stored in the user information storage unit 13a. Reservation information is registered in the reservation information storage unit 23a by accessing a reservation information site of each store published on the web from the user's mobile terminal or an external information processing device, logging in with an ID, a user name, or the like, and then inputting information according to a predetermined format.

ST22 of FIG. 2 is a diagram illustrating a configuration example of the reservation information storage unit 23a, and user reservation information stored in the reservation information storage unit 23a includes information (ID and user name) about the visiting user and a reservation time. Reservation information includes, as user information input from the user, information on the address, family structure, and business store.

The processing unit 21 of the information delivery device 20 includes an authentication unit 211, a checking unit 212, a change information acquisition unit 213, and an estimation unit 214 as functional configurations. These functional configurations are implemented by the processing unit 21 of the information delivery device 20 executing a predetermined program read from the storage unit 23. The configurations of the units of the functional configuration of the information delivery device 20 may be configured by an integrated circuit or the like as long as they perform similar functions.

The authentication unit 211 pre-authenticates the visiting user on the basis of a comparison between information acquired from an image of the visiting user who enters the facility (parking space and walking space) and user information (authentication information included in user information). Regarding a user whose data is stored in the user information storage unit 13a, the authentication unit 211 identifies the identification information (ID) and the user name of the visiting user by pre-authentication. Regarding a user whose data is not stored in the user information storage unit 13a, the authentication unit 211 identifies the user as a new user by pre-authentication.

The checking unit 212 checks information about the visiting user pre-authenticated by the authentication unit 211 against reservation information stored in the reservation information storage unit 23a. When ID=001 and user name “A” are set as key information for the information about the visiting user, the checking unit 212 identifies that a reservation time of “13:00” is set for the visitor (visiting user) with the ID=001 and the user name “A” as reservation information stored in the reservation information storage unit 23a.

The communication unit 22 outputs visit information obtained by combining the information about the visiting user and the reservation information checked by the checking unit 212 to a customer service support unit in the store. The customer service support unit in the store includes the guide robot 30 and the terminal device 40 of the sales representative. That is, the communication unit 22 transmits the visit information to the terminal device 40 of the sales representative (facility staff) and the guide robot 30 that provides customer service to the visiting user. By transmitting user information to the customer service support unit, it is possible to grasp information about the visiting user at an early stage at the time of visiting and provide customer service. For example, a sales representative (facility staff) can perform communication such as calling the name of the visiting user, and can proceed with smooth business negotiation.

The communication unit 22 can transmit the visit information not only to the terminal device 40 and the guide robot 30, but also to a display device or an information processing device for sharing user information about the visiting user in the store. As a result, it is possible to grasp information about the visiting user at the time of visiting and share the information in the store, and it is possible to provide customer service in cooperation in the store.

The change information acquisition unit 213 acquires change information on a changed item by checking user information corresponding to information about a visiting user against reservation information. The change information acquisition unit 213 acquires the user information (information on user's address, user's family structure, business store, and business history) corresponding to the information about the visiting user from the user information storage unit 13a of the shared information server 10, and checks the user information against the user information included in the reservation information to acquire the change information on the changed item.

Change information includes a change in store information where the business store serving the visiting user is changed from another store to the self-store. In a case where store information has been changed, the change information acquisition unit 213 acquires, as change information, information on a business history at another store from user information stored in the user information storage unit 13a.

Additionally, change information includes a change in address information on the visiting user and a change in the family structure of the visiting user.

The estimation unit 214 estimates the reason for visit of the visiting user on the basis of the change information. For example, when the business store has been changed from another store to the self-store, the estimation unit 214 estimates a reason for visit attributable to a past business history at the other store.

When the address information on the visiting user has been changed, the estimation unit 214 estimates a reason for visit attributable to the change in the address information, such as visiting a store close to the changed address information.

When the family structure of the visiting user has been changed, the estimation unit 214 estimates a reason for visit attributable to the change in the family structure, such as visiting for purchasing a new car according to the changed family structure.

When the reason for visit is estimated by the estimation unit 214, the communication unit 22 transmits the visit information and the reason for visit estimated by the estimation unit 214 to the customer service support unit (guide robot 30 and terminal device 40).

By estimating the reason for visit of the visiting user and transmitting the reason to the customer service support unit (guide robot 30 and terminal device 40), for example, the guide robot 30 to which the reason for visit has been conveyed can change the customer service provided to the visitor by controlling the user interface on the basis of the reason for visit. Additionally, the sales representative having the terminal device 40 notified of the reason for visit can acquire the reason for visit of the visiting user at an early timing of the visit, and can reduce the uneasiness of the visitor and take an early service response corresponding to the reason for visit.

(Configuration of Guide Robot 30)

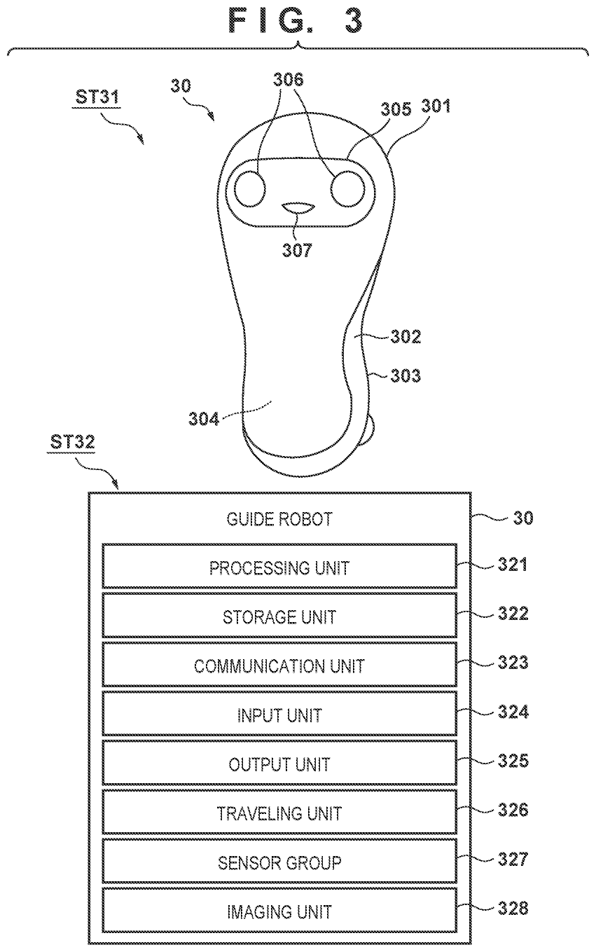

FIG. 3 is a diagram for describing a configuration of a guide robot. ST31 in FIG. 3 illustrates an external configuration of the guide robot, and ST32 is a diagram illustrating a functional configuration of the guide robot.

The guide robot 30 is a robot for providing customer service in the store 500. FIG. 5 illustrates the guide robot 30a that performs reception near the entrance 510 of the store 500 and the guide robot 30b that is present at a business negotiation between the sales representative 580 and the visiting user 590 in the business negotiation space 520a. In the following description, when referring to the robots with no distinction, the robots are referred to as the guide robot 30.

As illustrated in ST31 of FIG. 3, the guide robot 30 is formed in an upright substantially guitar-like shape, and roughly includes a head part 301, a constricted part 302, and a body part 303. In the present embodiment, the guide robot 30 has a height of about 110 cm. Additionally, the guide robot 30 has no limbs, and is configured to be movable by 360 degrees in any direction such as front, back, left, right, and oblique directions by a traveling device 304 provided at the lower end of the body part 303. Note that description of the specific configuration of the traveling device 304 will be omitted.

As described above, since the guide robot 30 has a head part 301 slightly larger than the body part 303 and has a shape without limbs, the guide robot 30 has, for example, a shape that allows a child to easily hold and communicate easily. Additionally, since the traveling device 304 enables the guide robot 30 to move while swaying in the front-and-rear direction and the left-and-right direction, the visiting user 590 can easily notice approach and the like, and the guide robot 30 can move so as to facilitate communication with the visiting user 590.

The head part 301 of the guide robot 30 is provided with a substantially elliptical face part 305 that is long in the horizontal direction, and the face part 305 is capable of displaying an expression of the guide robot 30, a simple character image, and the like. In the present embodiment, a pair of pseudo eyes 306 representing the eyes are displayed on the face part 305 of the guide robot 30, and various expressions can be expressed by the pair of pseudo eyes 306. For example, by changing the shape of the pair of pseudo eyes 306, expressions such as delight, anger, sorrow, and pleasure can be expressed. In the present embodiment, a pseudo mouth 307 representing the mouth is further displayed, and the shape of the pseudo mouth 307 is changed in addition to the pair of pseudo eyes 306, so that the change in the expression can be easily understood.

Additionally, the guide robot 30 is capable of moving the positions of the pair of pseudo eyes 306 in the face part 305. The guide robot 30 expresses the motion of moving the line of sight by changing the positions of the pair of pseudo eyes 306 in the face part 305.

Note that the mode of the guide robot 30 is an example, and robots of other modes can also be adopted. For example, the shape and the like of the guide robot 30 may be appropriately changed. Additionally, a stationary robot may be included as the robot, and, for example, a stationary robot may be disposed near the entrance 510 of the store 500 and in each of the business negotiation spaces 520a and 520b.

The guide robot 30 includes a processing unit 321, a storage unit 322, a communication unit 323, an input unit 324, an output unit 325, a traveling unit 326, a sensor group 327, and an imaging unit 328.

The processing unit 321 (control unit (CPU)) performs various types of processing for controlling the entire guide robot 30.

The storage unit 322 includes a ROM for storing a program to be executed by the processing unit 321, and a RAM for storing various types of information as a work area when the processing unit 321 executes the program. Additionally, the storage unit 322 includes a large-capacity storage unit that stores various types of information including various types of information received from the information delivery device 20 (robot control server) and results of various types of analysis processing by the processing unit 321.

The communication unit 323 can bidirectionally communicate with the information delivery device 20 (robot control server) through the network NW.

The processing unit 321 (control unit) can perform various types of information processing and control each unit of the guide robot 30, on the basis of information transmitted from the information delivery device 20 (robot control server) through the communication unit 323.

The input unit 324 accepts various inputs. The input unit 324 may be, for example, various switch buttons that can be operated at the time of maintenance or the like, a microphone that accepts a voice input of the visiting user 590, an operation panel that accepts an input of reservation information by the visiting user 590, or the like.

The output unit 325 outputs various types of information. The output unit 325 may be, for example, a speaker capable of outputting sound or a display unit such as a display capable of displaying an image. In the present embodiment, the face part 305 functions as the output unit 325 that displays an image.

The processing unit 321 (control unit) of the guide robot 30 changes the customer service provided to the visiting user under the control of the output unit 325 (user interface) based on the visit information and the change information transmitted from the information delivery device 20 (robot control server). For example, when information on the business store is changed from SP1 (another store) to SP2 (self-store), the processing unit 321 (control unit) can control the output unit 325 to output a voice based on the change information (“Thank you for doing business with us at the business store SP1. Thank you for your first visit to the business store SP2. We hope to continue doing business with you at the business store SP2 in the same way as at the business store SP1.”) or display an image.

Additionally, when change information is not included in the information received from the communication unit 22 of the information delivery device 20, the processing unit 321 (control unit) of the guide robot 30 provides customer service to the visiting user by controlling the user interface on the basis of the business history of the visiting user at the self-store, the business history being identified on the basis of the visit information. The processing unit 321 (control unit) can control the output unit 325 to output a voice based on the business history of the visiting user at the self-store (“Thank you for your visit since ∘th of ∘.”) or display an image.

The traveling unit 326 includes the above-described traveling device 304 or the like that causes the guide robot 30 to travel in a self-propelling manner. The traveling unit 326 includes, for example, a battery and an electric motor, and is configured such that the electric motor is driven by electric power supplied from the battery. The traveling unit 326 can be appropriately configured using a known electric technique.

The sensor group 327 may include various sensors including a sensor that detects a traveling and stop state of the guide robot 30 such as a traveling speed sensor, an acceleration sensor, and a gyro sensor, and a sensor that detects a state around the guide robot 30 such as an obstacle sensor, a human sensor, and a moving body sensor.

The imaging unit 328 is a camera having an imaging device such as a CCD or a CMOS, and is capable of imaging a visiting user who visits the store. The imaging unit 328 is provided, for example, on the head part 301 of the guide robot 30. With such an arrangement, it is easy to image the face of the visiting user. Additionally, from the viewpoint of imaging the face of the visiting user, the imaging unit 328 may be provided near the pair of pseudo eyes 306 of the guide robot 30.

(Configuration of Terminal Device 40)

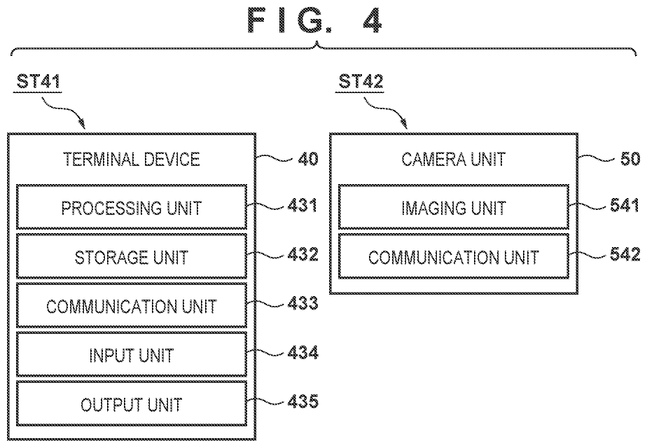

ST41 of FIG. 4 is a diagram illustrating a functional configuration of the terminal device 40. The terminal device 40 includes a processing unit 431, a storage unit 432, a communication unit 433, an input unit 434, and an output unit 435.

The processing unit 431, the storage unit 432, and the communication unit 433 can have configurations similar to those of the processing unit 321, the storage unit 322, and the communication unit 323 of the guide robot 30. The processing unit 431 (control unit (CPU)) performs various types of processing in the terminal device 40.

The storage unit 432 includes a ROM for storing a program executed by the processing unit 431, and a RAM for storing various types of information as a work area when the processing unit 431 executes the program. Additionally, the storage unit 432 includes a storage unit that stores various types of information received from the information delivery device 20 (robot control server).

The communication unit 433 can bidirectionally communicate with the information delivery device 20 (robot control server) through the network NW.

The input unit 434 accepts various inputs by the sales representative. The input unit 434 is a touch panel, for example. The output unit 435 outputs various types of information. The output unit 435 may be, for example, a speaker capable of outputting sound or a display unit such as a display capable of displaying an image.

The processing unit 431 (control unit) of the terminal device 40 gives notification of the reason for visit of the visiting user under the control of the output unit 435 based on the visit information and the change information.

Additionally, when change information is not included in the information received from the communication unit 22 of the information delivery device 20, the processing unit 431 (control unit) of the terminal device 40 gives notification of the reason for visit of the visiting user under the control of the output unit 435 based on the business history of the visiting user at the self-store, the business history being identified on the basis of the visit information.

The sales representative having the terminal device 40 notified of the reason for visit can acquire the reason for visit of the visiting user at an early timing of the visit, and can reduce the uneasiness of the visitor and take an early service response corresponding to the reason for visit.

(Configuration of Camera Unit 50)

ST42 of FIG. 4 is a diagram illustrating a functional configuration of the camera unit 50. The camera unit 50 includes an imaging unit 541 and a communication unit 542. The imaging unit 541 of the camera unit 50 can capture a still image or a moving image, and a digital camera including an image sensor such as a complementary metal-oxide semiconductor (CMOS) sensor or a charge coupled device (CCD) sensor is used as the imaging unit 541, for example. The communication unit 542 can bidirectionally communicate with the information delivery device 20 through the network NW. The communication unit 542 transmits the image (image information) captured by the imaging unit 541 to the information delivery device 20.

(Processing Flow)

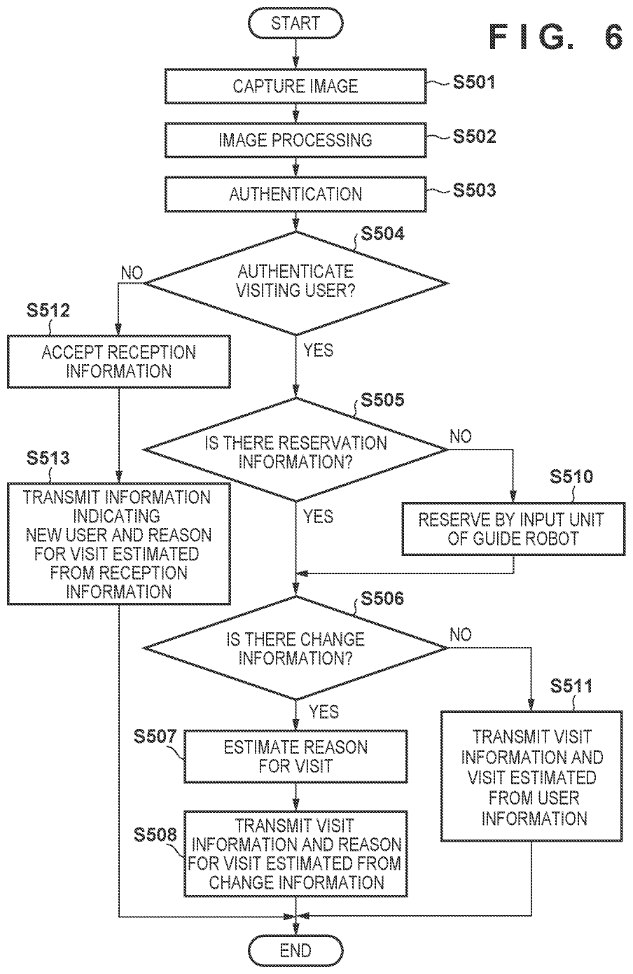

FIG. 6 is a diagram for describing a flow of processing in the information delivery system STM. In S501, the camera unit 50 captures an image for authentication of the visiting user. The camera unit 50a disposed in a facility outside the store captures an image of information on a license plate of a vehicle that enters the parking space, and transmits the image to the information delivery device 20. Additionally, the camera unit 50a disposed in a facility outside the store captures a face image of a visiting user in the walking space, and transmits the image to the information delivery device 20.

The camera units 50b and 50c disposed in the store 500 capture a face image of the visiting user 590 who enters the store and transmit the face image to the information delivery device 20.

In S502, the authentication unit 211 applies a known image processing technique to images (image information) transmitted from the camera units 50a, 50b, and 50c to acquire (extract) the information on the license plate of the vehicle entering the parking space and information on the face image of the visiting user.

In S503, the authentication unit 211 acquires user information (authentication information included in user information) acquired from the user information storage unit 13a of the shared information server 10. Then, the authentication unit 211 authenticates the visiting user by comparing the information acquired by image processing with the authentication information acquired from the user information storage unit 13a of the shared information server 10.

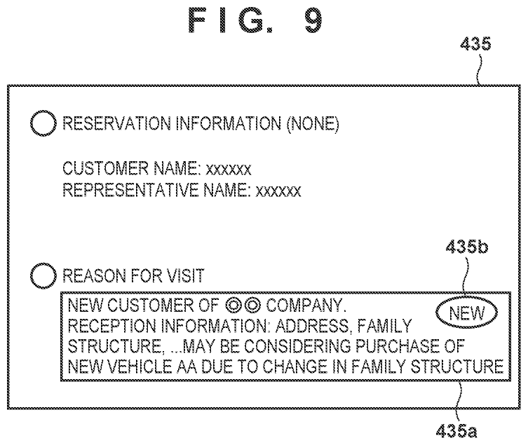

In S504, the authentication unit 211 determines whether or not information corresponding to the information acquired by image processing is included in the authentication information. If information corresponding to the information acquired by image processing is not included in the authentication information (No in S504), the authentication unit 211 identifies that the user is a new user by pre-authentication, and generates information (visit information) indicating that the user is a new user. The authentication unit 211 generates, for example, character information and an identification display (icon) indicating that the user is a new user as information (visit information) indicating that the user is a new user, and advances the processing to S512. As the identification display (icon), for example, a character and an arbitrary figure, symbol, or the like can be combined as in an identification display 435b of FIG. 9.

In S512, the input unit 324 of the guide robot 30a that performs reception near the entrance 510 of the store 500 accepts input of reception information. Reception information includes, for example, information such as a name, an address, and a family structure.

When reception information is input by a visiting user, the estimation unit 214 estimates a reason for visit on the basis of the reception information.

In S513, the communication unit 22 transmits information (visit information) indicating that the visiting user is a new user, reception information, and information on the reason for visit estimated from the reception information to the customer service support unit (guide robot 30 and terminal device 40). The information (visit information) indicating that the user is a new user includes character information (e.g., “New customer of ∘∘ company . . . ”) and an identification display (icon) indicating that the user is a new user.

When no reception information is input or when the reason for visit cannot be estimated on the basis of the reception information, the communication unit 22 transmits information (visit information) indicating that the visiting user is a new user to the customer service support unit (guide robot 30 and terminal device 40).

FIG. 9 is a diagram illustrating a display example of the terminal device 40 that gives notification of a visiting user who is a new user. The processing unit 431 (control unit) of the terminal device 40 displays, on a display unit 435a, information indicating that the visiting user is a new user, reception information, and a reason for visit estimated from the reception information under the control of the output unit 435 based on information received from the communication unit 22 of the information delivery device 20. In the display example of FIG. 9, character information (“New customer of ∘∘ company . . . ”) and an identification display 435b indicating that the user is a new user are displayed on the display unit 435a as information (visit information) indicating that the user is a new user. By viewing the identification display 435b, the sales representative (facility staff) can grasp at an early stage at the time of visiting that the visiting user is a new user, and can provide customer service. Furthermore, by confirming the character information and the reception information, it is possible to perform specific communication and proceed with smooth business negotiation.

At this time, the processing unit 321 (control unit) of the guide robot 30 changes the customer service provided to the visiting user under the control of the output unit 325 (user interface) based on information transmitted from the information delivery device 20 (robot control server). For example, the processing unit 321 (control unit) can control the output unit 325 to output a voice (“Thank you for your first visit to the business store of ∘∘ company.” or display an image.

On the other hand, if information corresponding to the information acquired by image processing is included in the authentication information in the determination of S504 (Yes in S504), the corresponding visiting user (ID and user name) is identified. Since the information about the visiting user is stored in the user information storage unit 13a, the authentication unit 211 determines that the user owns a vehicle of the manufacturer, and advances the processing to S505.

In step S505, the checking unit 212 checks information (ID and user name) about the visiting user pre-authenticated by the authentication unit 211 against reservation information stored in the reservation information storage unit 23a. If the reservation information is not stored in the reservation information storage unit 23a (No in S505), the checking unit 212 advances the processing to S510.

In S510, the input unit 324 of the guide robot 30a that performs reception near the entrance 510 of the store 500 accepts input of reservation information. When the input of the reservation information is accepted, the processing proceeds to S506.

On the other hand, if reservation information regarding the information about the visiting user (ID and user name) is stored in the reservation information storage unit 23a in the determination of S505 (Yes in S505), the checking unit 212 advances the processing to S506.

In S506, the change information acquisition unit 213 acquires user information (information on user's address, user's family structure, business store, and business history) corresponding to the information (ID and user name) about the visiting user from the user information storage unit 13a of the shared information server 10, and checks the user information against the user information included in the reservation information to acquire change information on the changed item. If it is determined in S506 that the change information acquisition unit 213 cannot acquire change information (if there is no change information, i.e., No in S506), the change information acquisition unit 213 advances the processing to S511.

In S511, the communication unit 22 transmits visit information obtained by combining the information about the visiting user and the reservation information to the customer service support unit (guide robot 30 and terminal device 40). Here, even when there is no change information, the estimation unit 214 estimates the reason for visit on the basis of user information if estimation can be made on the basis of the user information. When the reason for visit can be estimated on the basis of the user information, the communication unit 22 transmits the visit information and information indicating the reason for visit estimated from the user information to the customer service support unit (guide robot 30 and terminal device 40).

FIG. 8 is a diagram illustrating a display example of the terminal device 40 that gives notification of a visiting user when there is no change information. The processing unit 431 (control unit) of the terminal device 40 displays, on the display unit 435a, visit information about the visiting user and the reason for visit estimated from the user information under the control of the output unit 435 based on information received from the communication unit 22 of the information delivery device 20.

At this time, the processing unit 321 (control unit) of the guide robot 30 changes the customer service provided to the visiting user under the control of the output unit 325 (user interface) based on information transmitted from the information delivery device 20 (robot control server). For example, the processing unit 321 (control unit) can control the output unit 325 to output a voice (“Thank you for your visit since ∘th of ∘.” or “Thank you for coming to our store. The inspection date of your car is approaching . . . ”) or display an image.

On the other hand, if the change information acquisition unit 213 can acquire change information in S506 (If there is change information, i.e., Yes in S506), the change information acquisition unit 213 advances the processing to S507.

In S507, the estimation unit 214 estimates the reason for visit of the visiting user on the basis of the change information. Change information includes a change in store information in which the business store serving the visiting user is changed from another store to the self-store, a change in address information on the visiting user, a change in family structure of the visiting user, and the like. The estimation unit 214 estimates the reason for visit of the visiting user on the basis of the change information.

Then, in S508, the communication unit 22 transmits visit information obtained by combining the information about the visiting user and the reservation information, and information indicating the reason for visit to the customer service support unit (guide robot 30 and terminal device 40).

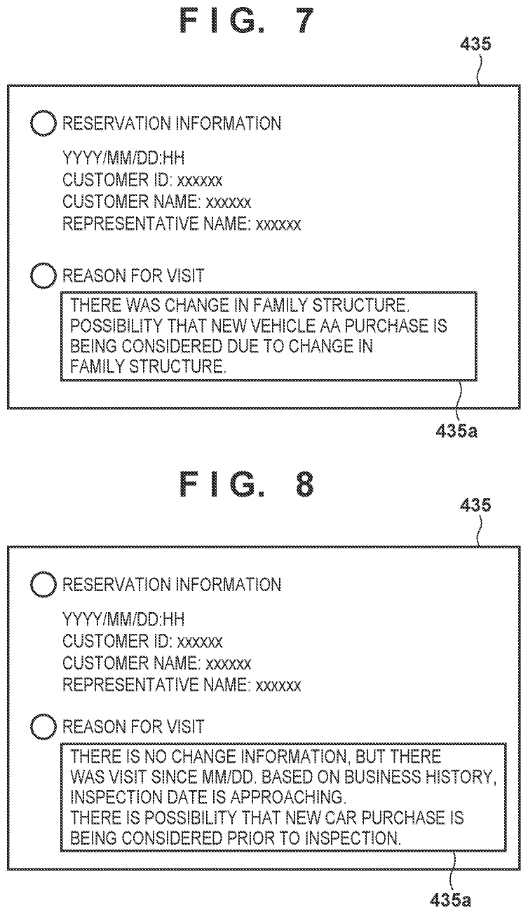

FIG. 7 is a diagram illustrating a display example of the terminal device 40 that gives notification of a visiting user when there is change information. The processing unit 431 (control unit) of the terminal device 40 displays, on the display unit 435a, visit information on the visiting user and the reason for visit estimated from the change information under the control of the output unit 435 based on information received from the communication unit 22 of the information delivery device 20. In the display example of FIG. 7, for example, the reason for visit estimated from the change in the family structure is displayed on the display unit 435a as the change information.

At this time, the processing unit 321 (control unit) of the guide robot 30 changes the customer service provided to the visiting user under the control of the output unit 325 (user interface) based on information transmitted from the information delivery device 20 (robot control server). For example, the processing unit 321 (control unit) controls the output unit 325 to output a voice (“Thank you for doing business with us at the business store SP1. Thank you for your first visit to the business store SP2. We hope to continue doing business with you at the business store SP2 in the same way as at the business store SP1.”) or display an image.

### Summary of Embodiment

The above embodiment discloses at least the following information delivery system, information delivery method, and program.

Configuration 1. An information delivery system according to the above embodiment including:

a user information storage unit (13a) configured to store user information;

a reservation information storage unit (23a) configured to store reservation information accepted from a user in association with the user information;

an authentication unit (211) configured to authenticate a visiting user who enters a facility on the basis of a comparison between information acquired from an image of the visiting user and the user information;

a checking unit (212) configured to check the information about the visiting user authenticated by the authentication unit against the reservation information stored in the reservation information storage unit; and

a communication unit (22) configured to output, to a customer service support unit (30, 40), visit information obtained by combining the information about the visiting user checked by the checking unit and the reservation information.

According to the information delivery system of Configuration 1, by transmitting the user information to the customer service support unit, it is possible to grasp the information about the visiting user and provide customer service. For example, a sales representative (facility staff) can perform communication such as calling the name of the visiting user, and can proceed with smooth business negotiation.

Configuration 2. The information delivery system according to the above embodiment, in which the communication unit (22) transmits the visit information to a terminal device (40) of a sales representative and a guide robot (30) that provides customer service to the visiting user that serve as the customer service support unit (30, 40).

According to the information delivery system of Configuration 2, by transmitting the user information to the terminal device of the sales representative and the guide robot that provides customer service to the visiting user, it is possible to grasp the information about the visiting user and provide customer service.

Configuration 3. The information delivery system according to the above embodiment further including:

a change information acquisition unit (213) configured to acquire change information on a changed item by checking the user information corresponding to the information about the visiting user against the reservation information; and

an estimation unit (214) configured to estimate a reason for visit of the visiting user on the basis of the change information, in which

the communication unit (22) transmits the visit information and the reason for visit estimated by the estimation unit to the customer service support unit (30, 40).

Configuration 4. The information delivery system according to the above embodiment, in which the change information includes a change in store information in which a business store serving the visiting user is changed from another store to the self-store.

Configuration 5. The information delivery system according to the above embodiment, in which when the store information is changed, the change information acquisition unit (213) acquires, as the change information, information on a business history at the other store from the user information storage unit (13a).

Configuration 6. The information delivery system according to the above embodiment, in which the change information includes a change in address information on the visiting user.

Configuration 7. The information delivery system according to the above embodiment, in which the change information includes a change in a family structure of the visiting user.

According to the information delivery systems of Configurations 3 to 7, by estimating the reason for visit of the visiting user and transmitting the reason to the customer service support unit (guide robot 30, terminal device 40), for example, the guide robot to which the reason for visit has been conveyed can change the customer service provided to the visitor by controlling the user interface on the basis of the reason for visit. Additionally, the sales representative having the terminal device notified of the reason for visit can acquire the reason for visit of the visiting user at an early timing of the visit, and can reduce the uneasiness of the visitor and take an early service response corresponding to the reason for visit.

Configuration 8. The information delivery system according to the above embodiment, in which a control unit (321) of the guide robot (30) changes the customer service provided to the visiting user under the control of an output unit (325) based on the visit information and the change information.

According to the information delivery system of Configuration 8, the guide robot can change the customer service provided to the visitor by controlling the user interface on the basis of the reason for visit.

Configuration 9. The information delivery system according to the above embodiment, in which a control unit (431) of the terminal device (40) gives notification of the reason for visit of the visiting user under the control of an output unit (435) based on the visit information and the change information.

According to the information delivery system of Configuration 9, the sales representative having the terminal device notified of the reason for visit can acquire the reason for visit of the visiting user at an early timing of the visit, and can reduce the uneasiness of the visitor and take an early service response corresponding to the reason for visit.

Configuration 10. The information delivery system according to the above embodiment, in which when the change information is not included in the information received from the communication unit (22), the control unit (321) of the guide robot (30) provides customer service to the visiting user under the control of the output unit (325) based on a business history of the visiting user at the self-store, the business history being identified on the basis of the visit information.

According to the information delivery system of Configuration 10, the guide robot can change the customer service provided to the visitor by controlling the user interface on the basis of the business history at the self-store.

Configuration 11. The information delivery system according to the above embodiment, in which when the change information is not included in the information received from the communication unit (22), the control unit (431) of the terminal device (40) gives notification of the reason for visit of the visiting user under the control of the output unit (435) based on the business history of the visiting user at the self-store, the business history being identified on the basis of the visit information.

According to the information delivery system of Configuration 11, the sales representative having the terminal device notified of the reason for visit can acquire the reason for visit of the visiting user at an early timing of the visit, and can reduce the uneasiness of the visitor and take an early service response corresponding to the reason for visit.

Configuration 12. The information delivery system according to the above embodiment, in which

the authentication unit (211) determines, on the basis of a comparison between the information about the visiting user and the user information stored in the user information storage unit, that the visiting user is a new user when the information about the visiting user is not included in the user information, and

the communication unit (22) transmits a result of the determination as the visit information to the customer service support unit (30, 40).

According to the information delivery system of Configuration 12, by transmitting the result of the determination that the visiting user is a new user to the customer service support unit (guide robot 30, terminal device 40), the guide robot can change the customer service provided to the visitor by controlling the user interface on the basis of the result of the determination that the visiting user is a new user. The sales representative having the terminal device can acquire the result of the determination that the user is a new user at an early timing of the visit, and can reduce the uneasiness of the visitor and take an early service response.

Configuration 13. An information delivery method according to the above embodiment is an information delivery method in an information delivery system (STM) including a user information storage unit (13a) configured to store user information, and a reservation information storage unit (23a) configured to store reservation information accepted from a user in association with the user information, the information delivery method including:

authenticating (S503, S504) a visiting user who enters a facility on the basis of a comparison between information acquired from an image of the visiting user and the user information;

checking (S505) the information about the visiting user authenticated in the authenticating against the reservation information stored in the reservation information storage unit; and

outputting (S508) visit information obtained by combining the information about the visiting user checked in the checking and the reservation information to a customer service support unit.

Configuration 14. A program according to the above embodiment is a program that causes a computer to execute an information delivery method in an information delivery system including a user information storage unit configured to store user information, and a reservation information storage unit configured to store reservation information accepted from a user in association with the user information, the information delivery method including:

authenticating (S503, S504) a visiting user who enters a facility on the basis of a comparison between information acquired from an image of the visiting user and the user information;

checking (S505) the information about the visiting user authenticated in the authenticating against the reservation information stored in the reservation information storage unit; and

outputting (S508) visit information obtained by combining the information about the visiting user checked in the checking and the reservation information to a customer service support unit.

According to the information delivery method of Configuration 13 and the program of Configuration 14, by transmitting the user information to the customer service support unit, it is possible to grasp the information about the visiting user and provide customer service. For example, a sales representative (facility staff) can perform communication such as calling the name of the visiting user, and can proceed with smooth business negotiation.

### Other Embodiments

The present invention can also supply a program for implementing the functions of the above embodiment to an information delivery system or an information delivery device included in the information delivery system through a network or a storage medium, and one or more processors in a computer of the information delivery system (information delivery device, guide robot, and terminal device) can read the program and execute processing of the information delivery system.

The invention is not limited to the foregoing embodiments, and various variations/changes are possible within the spirit of the invention.

What is claimed is:

1. An information delivery system comprising:
a user information storage unit configured to store user information;
a reservation information storage unit configured to store reservation information accepted from a user in association with the user information;
an authentication unit configured to authenticate a visiting user who enters a facility on the basis of a comparison between information acquired from an image of the visiting user and the user information;
a checking unit configured to check the information about the visiting user authenticated by the authentication unit against the reservation information stored in the reservation information storage unit; and
a communication unit configured to output, to a customer service support unit, visit information obtained by combining the information about the visiting user checked by the checking unit and the reservation information.

2. The information delivery system according to claim 1, wherein the communication unit transmits the visit information to a terminal device of a sales representative and a guide robot that provides customer service to the visiting user, which serve as the customer service support unit.

3. The information delivery system according to claim 2, further comprising:
a change information acquisition unit configured to acquire change information on a changed item by checking the user information corresponding to the information about the visiting user against the reservation information; and
an estimation unit configured to estimate a reason for visit of the visiting user on the basis of the change information, wherein
the communication unit transmits the visit information and the reason for visit estimated by the estimation unit to the customer service support unit.

4. The information delivery system according to claim 3, wherein the change information includes a change in store information in which a business store serving the visiting user is changed from another store to the self-store.

5. The information delivery system according to claim 4, wherein when the store information is changed, the change information acquisition unit acquires, as the change information, information on a business history at the other store from the user information storage unit.

6. The information delivery system according to claim 3, wherein the change information includes a change in address information on the visiting user.

7. The information delivery system according to claim 3, wherein the change information includes a change in a family structure of the visiting user.

8. The information delivery system according to claim 3, wherein a control unit of the guide robot changes the customer service provided to the visiting user under the control of an output unit based on the visit information and the change information.

9. The information delivery system according to claim 3, wherein a control unit of the terminal device gives notification of the reason for visit of the visiting user under the control of an output unit based on the visit information and the change information.

10. The information delivery system according to claim 4, wherein when the change information is not included in the information received from the communication unit, a control unit of the guide robot provides customer service to the visiting user under the control of an output unit based on a business history of the visiting user at the self-store, the business history being identified on the basis of the visit information.

11. The information delivery system according to claim 4, wherein when the change information is not included in the information received from the communication unit, a control unit of the terminal device gives notification of the reason for visit of the visiting user under the control of an output unit based on a business history of the visiting user at the self-store, the business history being identified on the basis of the visit information.

12. The information delivery system according to claim 1, wherein
the authentication unit determines, on the basis of a comparison between the information about the visiting user and the user information stored in the user information storage unit, that the visiting user is a new user when the information about the visiting user is not included in the user information, and
the communication unit transmits a result of the determination as the visit information to the customer service support unit.

13. An information delivery method in an information delivery system including a user information storage unit configured to store user information, and a reservation information storage unit configured to store reservation information accepted from a user in association with the user information, the information delivery method comprising:
authenticating a visiting user who enters a facility on the basis of a comparison between information acquired from an image of the visiting user and the user information;
checking the information about the visiting user authenticated in the authenticating against the reservation information stored in the reservation information storage unit; and
outputting visit information obtained by combining the information about the visiting user checked in the checking and the reservation information to a customer service support unit.

14. A storage medium storing a program that causes a computer to execute an information delivery method in an information delivery system including a user information storage unit configured to store user information, and a reservation information storage unit configured to store reservation information accepted from a user in association with the user information, the information delivery method including:
authenticating a visiting user who enters a facility on the basis of a comparison between information acquired from an image of the visiting user and the user information;
checking the information about the visiting user authenticated in the authenticating against the reservation information stored in the reservation information storage unit; and
outputting visit information obtained by combining the information about the visiting user checked in the checking and the reservation information to a customer service support unit.
